(19) United States
(12) Patent Application Publication
(10) Pub. No.: US 2014/0029139 A1
(43) Pub. Date: Jan. 30, 2014

(54) READ/WRITE HEAD WITH ADJUSTABLE FLY HEIGHT

(71) Applicants: Vincent B. ENGELKES, Maple Grove, MN (US); Huazhou LOU, Eden Prairie, MN (US)

(72) Inventors: Vincent B. ENGELKES, Maple Grove, MN (US); Huazhou LOU, Eden Prairie, MN (US)

(73) Assignee: SEAGATE TECHNOLOGY LLC, Cupertino, CA (US)

(21) Appl. No.: 13/560,135

(22) Filed: Jul. 27, 2012

(51) Int. Cl. G11B 5/127; G11B 5/60

(52) U.S. Cl. 360/235.4; 360/110; 360/234.3; G9B/5.229; G9B/5.04

(57) ABSTRACT

A transducing device may include features for adjusting the fly height between the transducing device and a magnetic storage medium. In one example, the transducing device includes a transducing element, at least one heating element, a permanently deformable material portion, and a temporarily deformable material portion. In this example, the permanently deformable material portion is configured to permanently deform in response to heat from the at least one heating element, and the temporarily deformable material portion is configured to temporarily deform in response to heat from the at least one heating element. The fly height of the device may be adjusted using lower temperatures and less energy than some other types of devices.

### BACKGROUND

Magnetic data storage devices include magnetic read/write heads that detect and modify the magnetic properties of a magnetic storage medium. For example, a magnetic read/write head may include a reader portion for retrieving magnetically-encoded information from a magnetic storage medium and a writer portion for magnetically encoding the information on the magnetic storage medium. Typically, the magnetic read/write head is mounted on a slider that slides or “flies” over the surface of a magnetic disc on an air bearing created by rotation of the magnetic disc.

The disc drive industry is continuously striving to increase the storage density of magnetic media by reducing the size of magnetically oriented domains (bits) on the media. As the size of the bits become smaller, it is necessary to bring read/write heads closer to the surfaces of magnetic discs in order to maintain good signal-to-noise ratios. At present, one technique used to bring a read/write head closer to the surface of a magnetic disc is to incorporate an actively actuatable material into the read/write head. During operation, the material can be actuated, for example, with application of heat, to protrude the read/write head closer to the surface of the magnetic disc.

While this thermal protrusion method can reduce the distance between a read/write head and the surface of a magnetic disc, the heating process associated with the technique can demand significant amounts of power. Further, prolonged operation at high temperatures may lead to device degradation and premature device failure.

### SUMMARY

In one aspect, the disclosure is directed to a transducing device that includes a transducing element, at least one heating element, a permanently deformable material portion, and a temporarily deformable material portion. According to this aspect, the transducing element is positioned within an electrically insulating material portion, and the at least one heating element is also positioned within the electrically insulating material portion. The permanently deformable material portion is formed within the electrically insulating material portion and configured to permanently deform in response to heat from the at least one heating element. The temporarily deformable material portion is formed within the electrically insulating material portion and configured to temporarily deform in response to heat from the at least one heating element.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a schematic diagram of an example disc drive.

FIG. 2 is a cross-sectional view of an example slider including transducing device that may be used in the example disc drive of FIG. 1.

FIG. 3 is an enlarged cross-sectional view of a trailing edge of the example slider of FIG. 2.

FIG. 4 is a cross-sectional view of another example configuration of the slider of FIG. 2.

FIGS. 5A-5C are conceptual illustrations of an example transducing device in different example states of deformation.

FIG. 6 is a flow chart illustrating an example method for operating a transducing device to adjust a fly height of the device.

### DETAILED DESCRIPTION

The following detailed description is to be read with reference to the drawings, in which like elements in different drawings have like reference numbers. The drawings, which are not necessarily to scale, are provided for illustrative purposes only and are not intended to limit the scope of the disclosure. Rather, the disclosure is intended to cover alternatives, modifications, and equivalents as may be included within the scope of the claims.

Larger data storage demands and technological advancements have led to increased data storage densities. Magnetic media are designed to accommodate a high number of tracks and a high number of magnetizations along the length of each track to meet the storage density demands. Techniques have further been developed to position read/write heads in close proximity to the surface of these magnetic media in order to maintain adequate signal-to-noise ratios with the high density media. For example, some read/write heads incorporate a thermally-controlled element that can be actively controlled during operation of the head to move the head closer to the surface of the magnetic media. The thermally-controlled element can expand in response to heat to position the read/write head in close proximity to the surface of the magnetic media. In turn, moving the read/write head in closer proximity to the magnetic media surface may improve signal-to-noise ratios for signals sensed and/or generated by the read/write head.

During operation of the read/write head, the thermally-controlled element may be heated to expand the element so that the read/write head protrudes closer to the surface of the magnetic media. For example, applying more heat to the thermally-controlled element may cause the read/write head to protrude closer to the magnetic media, while removing heat from the thermally-controlled element may withdraw the read/write head from the magnetic media. Although this actively controllable thermal element can function to position the read/write head in close proximity to a magnetic medium, the technique may draw considerable amounts of power during operation of a magnetic storage media. Further, the amount of heat required to achieve low separation values between the read/write head and the magnetic media may result in high internal and surface temperatures for the magnetic read/write head. These high temperatures may degrade the read/write head and lead to premature head failure, for example, via thermal failure of a heating element or through accelerated oxidative reaction of head materials.

This disclosure describes a transducing device (e.g., of a read/write head) that may be used to adjust the position of a transducing element relative to the surface of a magnetic media. In one example, the transducing device includes at least one heating element, a permanently deformable material portion, and a temporarily deformable material portion. The permanently deformable material portion may permanently deform in response to heat from the at least one heating element. The temporarily deformable material portion may temporarily deform in response to heat from the at least one heating element. During operation, the permanently deformable material portion can be permanently deformed, e.g., to permanently move a transducing element closer to the surface of a magnetic disc. This may be a one-time operation, e.g., performed during initiation of the transducing device. During subsequent operation, the temporarily deformable material portion may be temporarily deformed, e.g., to controllably adjust the position of the transducing element relative to the magnetic disc.

Depending on the configuration of the transducing device, the transducing device may position a transducing element in close proximity to the surface of a magnetic media while consuming less power and heating the transducing element to a lower temperature than other types of transducing devices. For example, the permanently deformable material portion may be permanently deformed to move the transducing element a first distance toward a magnetic media. This permanent deformation may be maintained even after heat is withdrawn from the permanently deformable material. Subsequently, the temporarily deformable material portion may be temporarily deformed to move the transducing element a second distance toward the magnetic media. This may facilitate controlled movement of the transducing device relative to the magnetic media surface. In addition, the distance that the transducing element is actively moved during any given operation may be reduced compared to other types of transducing devices. This may reduce the amount of heat and, hence energy, required during operation of the transducing device.

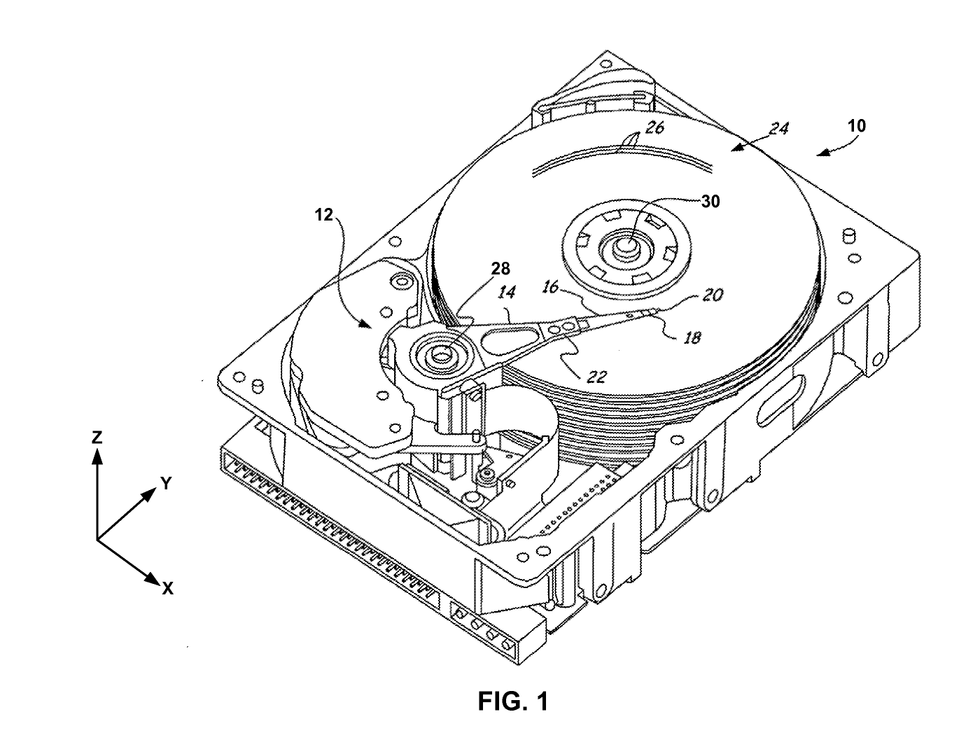

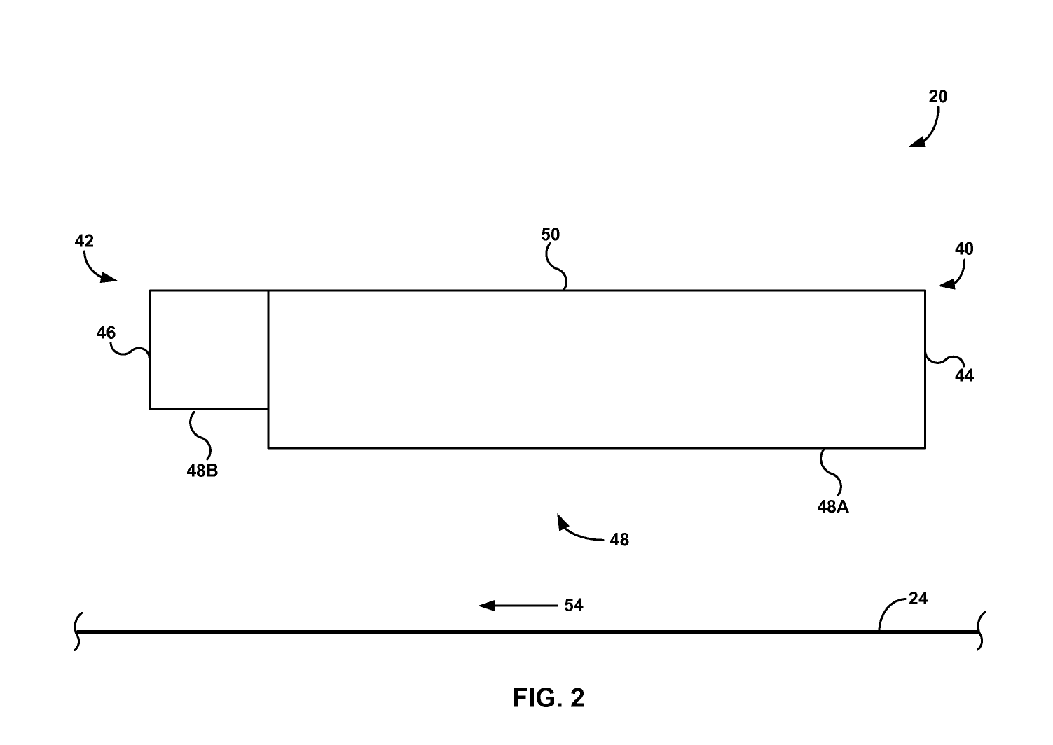

Example transducing devices are described in greater detail with reference to FIGS. 2-5. However, an example disc drive that includes a slider body and a transducing device will first be described with reference to FIG. 1.

FIG. 1 is a schematic diagram of an example disc drive 10, which may include a transducing device in accordance with the disclosure. In the example of FIG. 1, disc drive 10 includes a power source 12 (e.g., a voice coil motor), an actuator arm 14, a suspension 16, a flexure 18, a slider 20, a head mounting block 22, and a magnetic disc 24. Actuator arm 14 is connected to a proximal portion of suspension 16 at head mounting block 22. Slider 20 is connected at a distal end of suspension 16 by flexure 18. The different components of disc drive 10 can be housed in a disc enclosure that is defined by a base and a cover (not shown in FIG. 1).

As will be described in greater detail with respect to FIGS. 2-5, slider 20 of disc drive 10 carries a read/write electromagnetic transducer (not shown in FIG. 1) that can be positioned over a recording track 26 of magnetic disc 24 for reading and/or writing data to magnetic disc 24. For instance, in one example, slider 20 carries a read/write electromagnetic transducer that includes a permanently deformable material portion and a temporarily deformable material portion. Heating the permanently deformable material portion may permanently move the transducer element towards the surface of magnetic disc 24 (thereby reducing the distance separating the transducer element from the magnetic disc). Heating the temporarily deformable material portion may further move the transducer element towards the surface of magnetic disc 24 (thereby further reducing the distance separating the transducer element from the magnetic disc).

In the example of FIG. 1, actuator arm 14 is coupled to power source 12, which may be a voice coil motor (VCM). During operation, power source 12 can selectively move actuator arm 14 around axis 28. Movement of actuator arm 14 in turn causes suspension 16 to rotate radially with respect to magnetic disc 24. Through this radial movement, the read/write electromagnetic transducer carried by slider 20 can be selectively positioned above a target recording track 26 on magnetic disc 24, e.g., between an innermost recording track and an outermost recording track.

In some examples, disc drive 10 is configured to move actuator arm 14 to a park position when the disc drive is powered down or idling. In these examples, disc drive 10 can include a ramp positioned adjacent an outer circumferential edge of magnetic disc 24. When disc drive 10 is stopped or idling, power source 12 rotates actuator arm 14 to a park position, e.g., such that actuator arm 14 contacts a portion of the ramp. This may unload the read/write electromagnetic transducer carried by slider 20 from magnetic disc 24. For instance, in one example when actuator arm 14 is moved to a park position, slider 20 is not located above magnetic disc 24 but rather is positioned to the side of the magnetic disc (e.g., in the X-Y plane indicated on FIG. 1).

In other examples, disc drive 10 is configured for contact start/stop actuation instead of park actuation. In these examples, power source 12 may rotate actuator arm 14 so that slider 20 is positioned on a non-data area of magnetic disc 24 (e.g., instead of entirely off of magnetic disc 24 as in park actuation operation). At power down or during idling, slider 20 contacts magnetic disc 24 as the slider slows down and slides to a halt. Conversely, during power up, slider 20 slides along magnetic disc 24 until a relative velocity between the slider 20 and magnetic disc 24 is sufficient to produce a lift force adequate to cause slider 20 to fly above the surface of the disc.

Disc drive 10 is configured to store information representative of data. For this reason, disc drive 10 may include at least one magnetic disc 24 which, in the example of FIG. 1, is illustrated as a plurality of magnetic discs. Magnetic disc 24 is attached to spindle hub 30, which rotates the magnetic disc during operation. Magnetic disc 24 may store information as magnetically oriented discrete domains on a magnetic film. For example, each discrete domain on the magnetic film may represent a bit of data, with one magnetic orientation representing a “0” and a substantially opposite magnetic orientation representing a “1.”

In different examples, disc drive 10 may include a single magnetic disc 24 or a plurality of magnetic discs (e.g., two, three, four, or more) attached to spindle hub 30, and it should be appreciated that the disclosure is not limited in this respect. In examples in which disc drive 10 includes a plurality of magnetic discs, the disc drive may also include a plurality of sliders carrying a plurality of read/write electromagnetic transducers, where a different one of the plurality of transducers is configured to read and/or write data to a different one of the plurality of magnetic discs. The plurality of sliders may be connected to a plurality of suspensions, e.g., via a comb-like structure that includes a plurality of actuator arms.

During operation of disc drive 10, rotation of magnetic disc 24 generates air movement between magnetic disc 24 and slider 20. This air movement can provide a lift force that causes slider 20 to lift off of magnetic disc 24. This air movement can also provide an air bearing that allows slider 20 to slide or “fly” at a low height above the top surface of magnetic disc 24, e.g., without contacting the magnetic disc.

The distance between a read/write electromagnetic transducer carried by slider 20 and the top surface of magnetic disc 24 (e.g., in the Z-direction indicated in FIG. 1) during operation of disc drive 10 may be referred to as a “fly height.” Controlling the fly height of disc drive 10 may help control the quality of signals sensed and/or generated by a read/write electromagnetic transducer carried by slider 20 of disc drive 10. For example, reducing the distance between the read/write electromagnetic transducer carried by slider 20 and the top surface of magnetic disc 24 may improve signal-to-noise ratios for signals detected and/or generated by the transducer. However, if distance between the read/write electromagnetic transducer carried by slider 20 and the top surface of magnetic disc 24 is reduced too much, the transducer may contact the disc during operation, which may damage the transducer or result in failure of the disc drive.

The configuration of disc drive 10 illustrated in FIG. 1 is merely one example of a disc drive that may include a transducing device in accordance with the disclosure. Disc drives having different mechanical configurations may be used. For example, a disc drive may have either rotary or linear actuation. Further, different types of disc drives that may be employed including, but are not limited to, hard disc drives, zip drives, and floppy disc drives. Other configurations of drives are both possible and contemplated.

FIG. 2 is a cross-sectional view of an example slider 20 that may be used in disc drive 10. In the example of FIG. 2, slider 20 is illustrated as an assembly that includes a slider body 40 and a read/write electromagnetic transducing device 42 (also referred to herein as “transducing device 42”). Slider 20 defines a leading edge 44 and a trailing edge 46 opposite leading edge 44. Slider 20 also defines an air bearing surface 48 that provides lift to slider 20 during operation and a non-air bearing surface 50 that is opposite air bearing surface 48. Specifically, in the example of FIG. 2, slider 20 defines a leading air bearing surface 48A that is adjacent leading edge 44 and a trailing air bearing surface 48B that is adjacent trailing edge 46, although slider 20 can have a different number or different configuration of air bearing surfaces.

In operation, slider 20 can be positioned adjacent magnetic disc 24 (FIG. 1). As magnetic disc 24 rotates in the direction indicated by arrow 54 on FIG. 2, pressure build-up under air bearing surface 48 causes slider 20 to lift off magnetic disc 24. The shape and design of slider 20 can vary, e.g., to change the flying, landing, and/or performance characteristics of the slider. However, in the example of FIG. 2, slider 20 is illustrated as having an elongated, substantially rectangular body with transducing device 42 positioned at the trailing end of slider body 40.

Slider body 40 can be made of a variety of different materials including, e.g., Al₂O₃, TiC, AlTiC, TiC, Si, SiC, ZrO₂, or combinations thereof. Transducing device 42 can be made of the same materials as slider body 40, or transducing device 42 can be made of different materials than slider body 40. In some examples, transducing device 42 is integrally (e.g., permanently) formed with slider body 40. In other examples, transducing device 42 is formed separately from slider body 40 and mechanically and/or electrically connected to slider body 40. Depending on the materials used to fabricate slider body 40 and transducing device 42, the intersection between slider body 40 and transducing device 42 may be defined as an intersection between two or more different materials, e.g., having different physical and/or chemical properties.

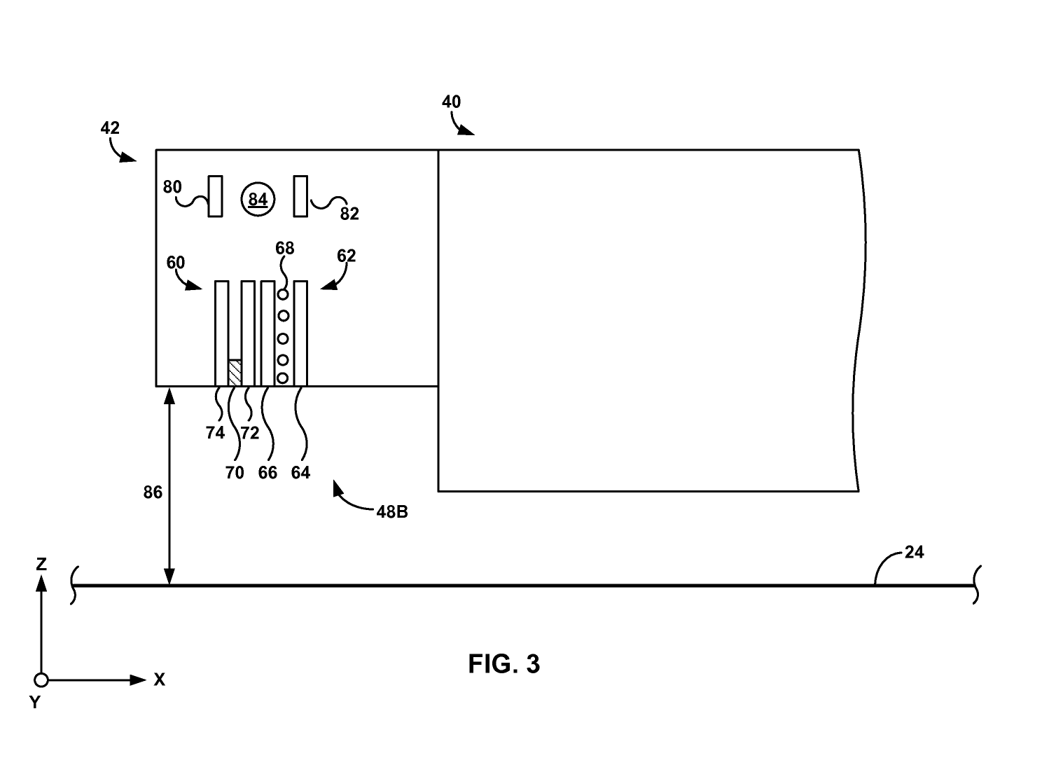

FIG. 3 is an enlarged cross-sectional view of the trailing edge of slider 20 illustrating an example configuration of transducing device 42. Transducing device 42 includes at least one transducing element which, in the example of FIG. 3, is illustrated as two transducing elements including a read element 60 and a write element 62. Write element 62 is configured to write data to magnetic disc 24 during a write operation while read element 60 is configured to read data from magnetic disc 24 during a read operation. Read element 60 may also be used to determine a separation distance between transducing device 42 and a top surface of magnetic disc 24, e.g., by detecting an amplitude change in a magnetic signal detected by read element 60 that is proportional to the separation distance.

In addition, transducing device 42 includes a permanently deformable material portion 80, a temporarily deformable material portion 82, and a heating element 84. Permanently deformable material portion 80 may permanently deform in response to heat from the heating element 84. Temporarily deformable material portion 82 may temporarily deform in response to heat from heating element 84. As discussed in greater detail below, permanently deformable material portion 80 and temporarily deformable material portion 82 may each deform to help position read element 60 and/or write element 62 in close proximity to magnetic disc 24.

Write element 62 can have a variety of different configurations. In the example of FIG. 3, write element 62 includes a leading pole 64, a trailing pole 66, and a write coil 68. Leading pole 64 and trailing pole 66 define a write gap. During a write operation, electrical current may be selectively directed through write coil 68 to induce a magnetic flux that produces a magnetic field at the write gap. The magnetic field can interact with the magnetically oriented discrete domains of magnetic disc 24 to store information on the disc.

Read element 60 can also have a number of different configurations. In the example of FIG. 3, read element 60 includes a magnetoresistive sensor 70, a first magnetic shield 72, and a second magnetic shield 74. Magnetoresistive sensor 70 is positioned between first magnetic shield 72 and second magnetic shield 74. In different examples, magnetoresistive sensor 70 may be a giant magnetoresistive (GMR) element, a tunnel junction magnetoresistive (TMR) element, or the like. Independent of the specific configuration of read element 60, the read element may be configured to retrieve magnetic data from magnetic disc 24 based on variation in the electrical resistance of the element in response to different magnetic fields stored on magnetic disc 24.

During operation of disc drive 10 (FIG. 1) transducing device 42 may fly over the surface of magnetic disc 24. The distance separating transducing device 42 from a top surface of magnetic disc 24 (e.g., in a direction substantially orthogonal to the planar upper surface of the disc) may be referred to as a “fly height.” An example fly height 86 is illustrated in FIG. 3. Fly height 86 may be substantially constant across transducing device 42 (e.g., in the X-Y plane indicated in FIG. 3), or fly height 86 may vary across the transducing device. For example, during operation of slider 20, the slider may be angled with respect to magnetic disc 24 rather than substantially parallel to the magnetic disc 24. In such an example, the trailing edge of transducing device 42 may be closer to the top surface of magnetic disc 24 than the leading edge of the transducing device. In another example, read element 60 and/or write element 62 may include a pole extension that projects substantially orthogonally away from the air bearing surface of transducing device 42. This pole extension may position read element 60 and/or write element 62 closer to the top surface of magnetic disc 24 than other portions of transducing device 42. Accordingly, rather than exhibiting a single fly height 86, in some examples, transducing device 42 may exhibit a plurality of local fly heights, where the local fly height may be considered the fly height of transducing device 42 at any local point along the transducing device.

Controlling fly height 86 of transducing device 42 may help control the quality of signals detected by read element 60 and/or generated by write element 62. For example, reducing the local fly height between read element 60 and/or write element 62 and the top of magnetic disc 24 may improve signal-to-noise ratios for signals detected by read element 60 and/or generated by write element 62.

In the example of FIG. 3, transducing device 42 includes permanently deformable material portion 80 and temporarily deformable material portion 82, which may each help position read element 60 and/or write element 62 in close proximity to the top of magnetic disc 24. Permanently deformable material portion 80 may permanently deform in response to heat generated by heating element 84. This deformation may remain even after heat is withdrawn (e.g., power is cut to heating element 84) from permanently deformable material portion 80. Conversely, temporarily deformable material portion 82 may temporarily deform in response to heat from heating element 84. Temporarily deformable material portion 82 may return to an undeformed state when heat is withdrawn from the material portion.

In one example, permanently deformable material portion 80 and temporarily deformable material portion 82 are each configured to expand in response to heat from heating element 84. Permanently deformable material portion 80 may expand (e.g., substantially in the Z-direction indicated on FIG. 3), causing read element 60 and/or write element 62 to move closer to magnetic disc 24 than before the permanently deformable material portion 80 is deformed. This expansion may reduce the local fly height in the area between the bottom of read element 60 and/or write element 62, and the top of magnetic disc 24. Further, this expansion may be permanent such that the distance separating read element 60 and/or write element 62 from the top of magnetic disc 24 (e.g., when magnetic disc 24 is rotating) is less after permanently deformable material portion 80 is deformed than before permanently deformable material portion 80 is deformed (e.g., even when heating element 84 is off).

Temporarily deformable material portion 82 may also expand (e.g., substantially in the Z-direction indicated on FIG. 3), causing read element 60 and/or write element 62 to move closer to magnetic disc 24 than before the temporarily deformable material portion 82 is deformed. Depending on the configuration of temporarily deformable material portion 82 and the position of the material (e.g., relative to permanently deformable material portion 80), temporarily deformable material portion 82 may expand substantially the same region of transducing device 42 expanded by permanently deformable material portion 80.

For instance, temporarily deformable material portion 82 may be positioned in the same region of transducing device 42 that permanently deformable material portion 80 is positioned. In such an example, the deformation of temporarily deformable material portion 82 may reduce the local fly height of transducing device 42 in the same region that permanently deformable material portion 80 reduces the local fly height of transducing device 42. That is, the local fly height reduction may be equal to the sum of the fly height reduction achieved by permanently deforming the permanently deformable material portion and the fly height reduction achieved by temporarily deforming the temporarily deformable material portion.

Expansion of temporarily deformable material portion 82 may reduce the distance separating read element 60 and/or write element 62 from the top of magnetic disc 24 (e.g., when magnetic disc 24 is rotating) to a distance less than before the temporarily deformable material portion 82 is deformed. Further, expansion of temporarily deformable material portion 82 may reduce the distance separating read element 60 and/or write element 62 from the top of magnetic disc 24 to a distance less than after permanently deformable material portion 80 is deformed.

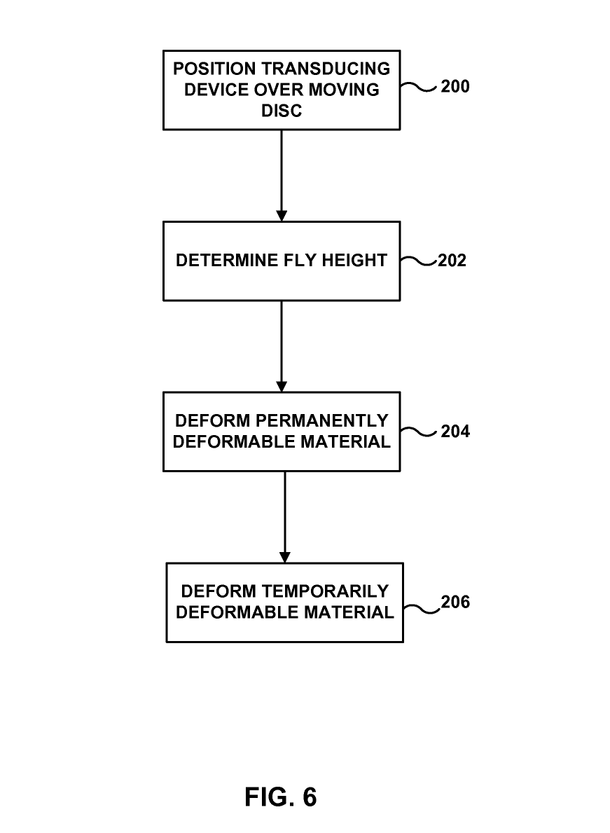

Permanently deformable material portion 80 may deform in response to heat generated by heating element 84. In some examples, as described in greater detail with respect to FIG. 6, permanently deformable material portion 80 may be deformed once, e.g., during initiation of transducing device 42. As transducing device 42 flies over magnetic disc 24 (e.g., during initial operation of disc drive 10), the distance separating read element 60 and/or write element 62 from the top surface of magnetic disc 24 may be monitored. Permanently deformable material portion 80 can then be deformed, e.g., until the distance separating read element 60 and/or write element 62 from the top surface of magnetic disc 24 is reduced below a threshold value. This permanent deformation can permanently reduce the fly height between read element 60 and/or write element 62 and magnetic disc 24.

The ability to permanently reduce the fly height between read element 60 and/or write element 62 and magnetic disc 24 may be useful to correct for manufacturing variations between any given transducing device and magnetic disc. Different disc drives may exhibit different fly heights after initial assembly, even though each disc drive is fabricated from similar components. Permanently deformable material portion 80 can be used to establish a substantially constant fly height across different disc drives.

Further, in examples in which permanently deformable material portion 80 is permanently expanded to reduce the fly height between read element 60 and/or write element 62 and magnetic disc 24, the amount of energy and/or operating temperature required to further reduce the fly height during operation (e.g., via temporarily deformable material portion 82) may be reduced. Specifically, permanently deformable material portion 80 can be permanently deformed to achieve a permanent fly height reduction. Accordingly, further fly height reduction (e.g., via temporarily deformable material portion 82) may be achieved with lower amounts of energy and/or at lower temperatures than if the entire fly height reduction is achieved solely by a temporarily deformable material.

Transducing device 42 in the example of FIG. 3 also includes temporarily deformable material portion 82. Temporarily deformable material portion 82 may be temporarily or reversibly deformed (e.g., expanded) in response to heat generated by heating element 84. Temporarily deformable material portion 82 may be deformed during operation of disc drive 10 (FIG. 1), e.g., to controllably adjust the fly height between read element 60 and/or write element 62 and magnetic disc 24. In some examples, increasing the amount of heat (e.g., temperature) generated by heating element 84 increases the degree of deformation of temporarily deformable material portion 82. In such an example, heating temporarily deformable material portion 82 to a first temperature may expand the material to set a first fly height, while heating the temporarily deformable material portion 82 to a second temperature greater than the first temperature may set a second fly height that is less than the first fly height. That is, temporarily deformable material portion 82 may deform more with increasing temperature (e.g., up to a threshold limit).

Transducing device 42 including permanently deformable material portion 80 and temporarily deformable material portion 82 can be fabricated from a variety of different materials. In some examples, transducing device 42 includes a body that comprises (or, optionally, consists or consists essentially of) an electrically insulating material such as, e.g., Al₂-O₃, AlN, SiO₂, Si₃N₄, SiC, SiON, polymeric materials (e.g., a polyimide) or combinations thereof. In some examples, read element 60, write element 62, permanently deformable material portion 80, and/or temporarily deformable material portion 82 are fabricated from different materials than the electrically insulating material body of transducing device 42. Such materials may be formed or positioned within the electrically insulating material to define transducing device 42.

In one example, temporarily deformable material portion 82 is a film (e.g., layer) or mass of material that expands in response to heat generated by heating element 84 and retracts to an unheated size when heat is removed from the material. Such material may be referred to as an elastically deformable material. Temporarily deformable material portion 82 may expand substantially unidirectionally (e.g., in the Z-direction indicated on FIG. 3) or in multiple directions.

Example materials for temporarily deformable material portion 82 may include Cu, Fe, Ti, and alloys thereof. In some examples, temporarily deformable material portion 82 may exhibit a yield stress greater than 60 megapascals (MPa) such as, e.g., greater than 150 MPa, greater than 300 MPa, or greater than 450 MPa. For instance, temporarily deformable material portion 82 may exhibit a yield stress between approximately 70 MPa and approximately 450 MPa. In some additional examples, temporarily deformable material portion 82 may exhibit a Young's modulus greater than 85 gigapascals (GPa) such as, e.g., greater than 95 GPa, greater than 100 GPa, or greater than 120 GPa. For instance, temporarily deformable material portion 82 may exhibit a Young's modulus between approximately 90 GPa and approximately 110 GPa.

Permanently deformable material portion 80 may be a film (e.g., layer) or mass of material that expands in response to heat generated by heating element 84 and that maintains its expanded size when heating element 84 stops generating heat. Such a material may be referred to as a plastically deformable material. Permanently deformable material portion 80 may expand substantially unidirectionally (e.g., in the Z-direction indicated on FIG. 3) or in multiple directions.

Example materials for permanently deformable material portion 80 may include Al, Al alloys, and one or more plastic materials. In some examples, permanently deformable material portion 80 is configured to undergo a phase change in response to heat generated by heating element 84. In some examples, permanently deformable material portion 80 may exhibit a yield stress less than 150 megapascals (MPa) such as, e.g., less than 50 MPa, less than 35 MPa, or less than 25 MPa. For instance, permanently deformable material portion 80 may exhibit a yield stress between approximately 40 MPa and approximately 15 MPa. In some additional examples, permanently deformable material portion 80 may exhibit a Young's modulus less than 80 gigapascals (GPa) such as, e.g., less than 70 GPa, or less than 60 GPa. For instance, permanently deformable material portion 80 may exhibit a Young's modulus between approximately 75 GPa and approximately 35 GPa.

Transducing device 42 can be constructed using any suitable manufacturing techniques. In some examples, integrated circuit manufacturing techniques such as chemical vapor deposition techniques, sputter techniques, or photolithography techniques may be used to fabricate transducing device 42. Thus, to the extent that different features of transducing device 42 are referred to in this disclosure as being positioned within or formed within an electrically insulating body, it should be appreciated that the features may be formed externally to and mechanically affixed with the insulating body, or the features may be integrally (e.g., permanently) formed with the insulating body, and the disclosure is not limited in this respect.

Transducing device 42 in the example of FIG. 3 also includes heating element 84. Heating element 84 may be any element that converts electrical energy into thermal energy for deforming permanently deformable material portion 80 and/or temporarily deformable material portion 82. In one example, heating element 84 is a heating coil, e.g., formed by winding a thin film resistive element and filling gaps in the element with an electrically insulative material. Heating element 84 may, but need not, generate a temperature greater than 150 degrees Celsius such as, e.g., a temperature greater than 200 degrees Celsius, or a temperature greater than 250 degrees Celsius. In some examples, heat element 84 is configured to operate at a power between approximately 30 milliwatt (mW) and approximately 150 mW, although other operating powers are possible.

Heating element 84 can be positioned at any suitable location within transducing device 42 including, e.g., the region proximate read element 60 and/or write element 62. For example, heating element 84 may be positioned in a region above read element 60 and/or write element 62 (e.g., in the Z-direction indicated in FIG. 3), although other locations are possible. In addition, transducing device 42 can include a single heating element 84 or a plurality of heating elements (e.g., two, three, four, or more heating elements).

In one example, transducing device 42 includes a single heating element 84. The single heating element 84 may be positioned closer to permanently deformable material portion 80 than temporarily deformable material portion 82, closer to temporarily deformable material portion 82 than permanently deformable material portion 80, or substantially equidistance from permanently deformable material portion 80 and temporarily deformable material portion 82. In some examples, the single heating element may be configured to operate at a first level of power to temporarily deform the temporarily deformable material portion 82 and a second level of power greater than the first level of power to permanently deform the permanently deformable material portion 80. For example, single heating element 84 may be configured to operate at a first power level of less than 50 mW (e.g., between 10 mW and 40 mW) to temporarily deform temporarily deformable material portion 82 and a second power level of greater than 50 mW (e.g., greater than 100 mW, or between 110 mW and 180 mW) to permanently deform permanently deformable material portion 80.

In another example, transducing device 42 includes two heating elements. Each heating element may or may not be independently controllable. In such an example, one of the heating elements may be positioned closer to permanently deformable material portion 80 than temporarily deformable material power 82, while the other heating element may be positioned closer to temporarily deformable material portion 82 than permanently deformable material portion 80. Alternatively, both heating elements may be positioned substantially equidistance from permanently deformable material portion 80 and temporarily deformable material portion 82. In still another alternative, both heating elements may be positioned closer to permanently deformable material portion 80 or temporarily deformable material portion 82 than the other material portion.

Depending on the positioning of the two heating elements in such an example, one heating element may be configured to control deformation of either permanently deformable material portion 80 or temporarily deformable material portion 82, while the other heating element may be configured to control deformation of the other material portion. Positioning one or more heating elements closer to permanently deformable material portion 80 than temporarily deformable material portion 82 may be useful in examples in which permanently deformable material portion 80 requires higher temperatures to deform than temporarily deformable material portion 82.

Permanently deformable material portion 80 and temporarily deformable material portion 82 can be formed at any suitable location with transducing device 42. Further, the location of each material portion may vary based, e.g., on the size, shape, and configuration of transducing device 42. In the example of FIG. 3, permanently deformable material portion 80 and temporarily deformable material portion 82 are illustrated as being positioned above read element 60 and write element 62, respectively, although the position of the material portions may be reversed. Further, in the example of FIG. 3, permanently deformable material portion 80 and temporarily deformable material portion 82 are illustrated as being located substantially the same distance above trailing air bearing surface 48B (i.e., in the Z-direction indicated on FIG. 3). In different examples, the material portions may be located at different elevations above trailing air bearing surface 48B.

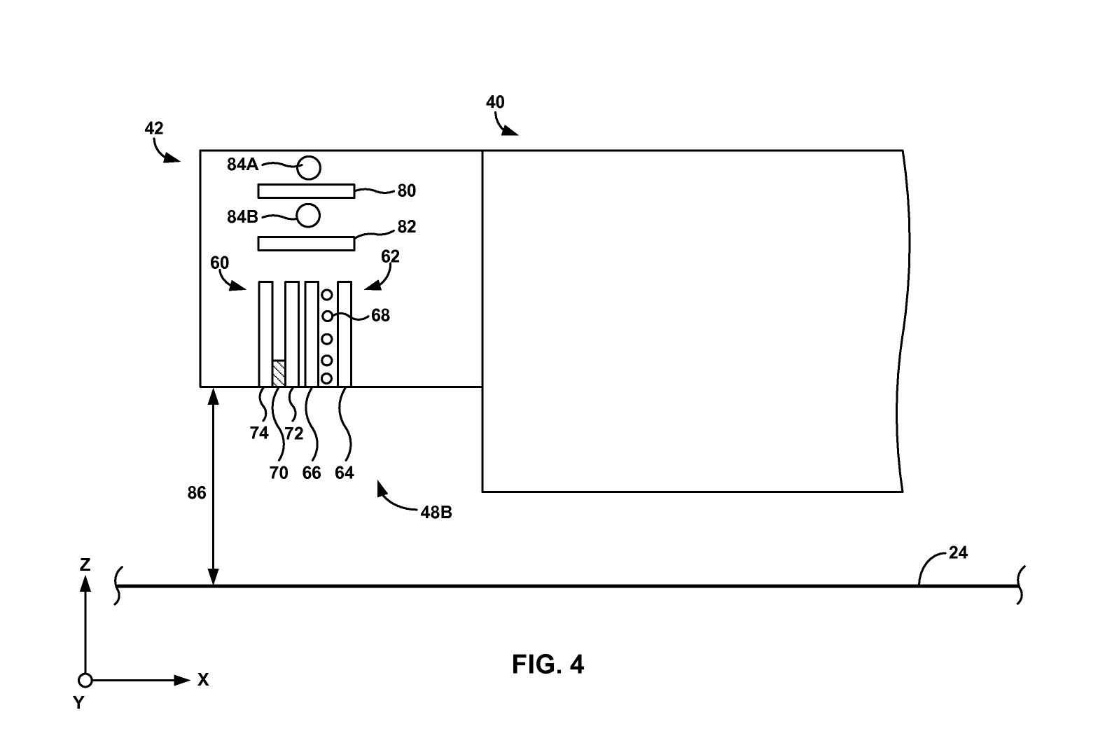

FIG. 4 is a cross-sectional illustration of an alternative example arrangement of permanently deformable material portion 80 and temporarily deformable material portion 82 in transducing device 42. In the example of FIG. 4, permanently deformable material portion 80 is arranged in a first layer substantially parallel to trailing air bearing surface 48B, and temporarily deformable material portion 82 is arranged as a second layer substantially parallel to trailing air bearing surface 48B. Further, permanently deformable material portion 80 is positioned a first distance from trailing air bearing surface 48B, while temporarily deformable material portion 82 is positioned a second distance trailing air bearing surface 48B. In FIG. 4, the first distance is greater than the second distance, although the position of permanently deformable material portion 80 and temporarily deformable material portion 82 may be reversed.

Transducing device 42 in the example of FIG. 4 also includes two heating elements 84A and 84B. Permanently deformable material portion 80 is positioned adjacent both heating element 84A and heating element 84B, while temporarily deformable material portion 82 is positioned adjacent heating element 84B. In such an arrangement, permanently deformable material portion 80 may be heated to a higher temperature (e.g., when both heating elements 84A and 84B are operating) than temporarily deformable material portion. Such an arrangement may be useful in examples in which permanently deformable material portion 80 requires higher temperatures to deform than temporarily deformable material portion 82.

The arrangement of heating elements and material portions in FIGS. 3 and 4 are merely two examples. Other arrangements are both possible and contemplated. Further, although transducing device 42 has been described as including one permanently deformable material portion and one temporarily deformable material, it should be appreciated that the transducing device can include a plurality (e.g., two, three, or more) of one or both material portions, and the disclosure is not limited in this respect.

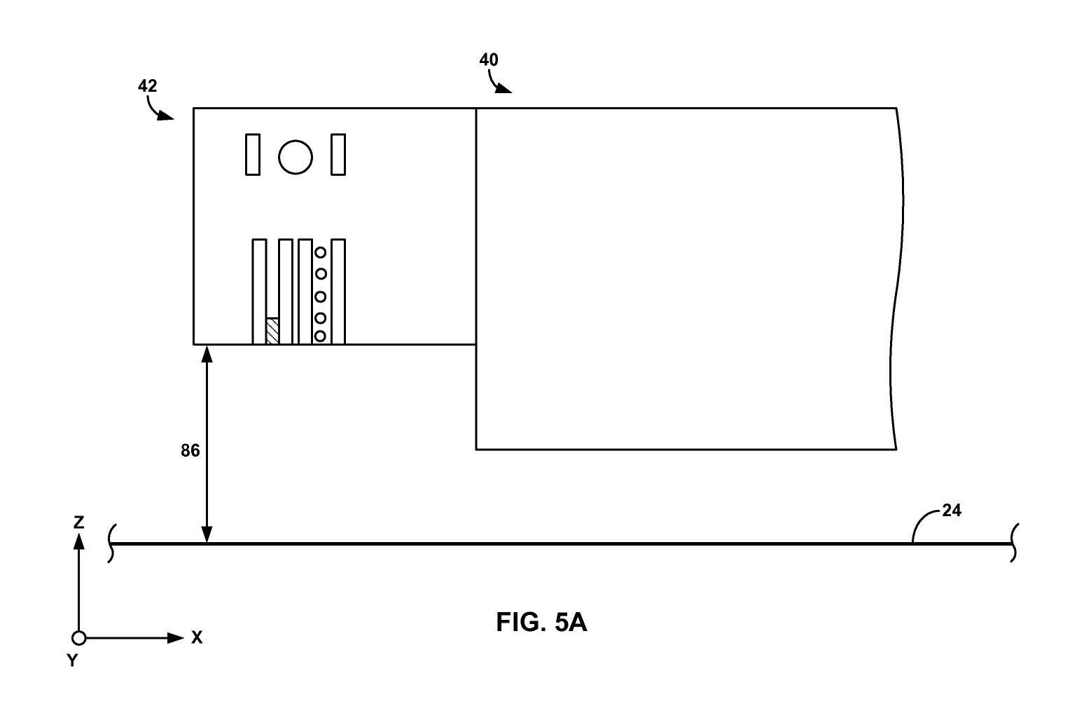

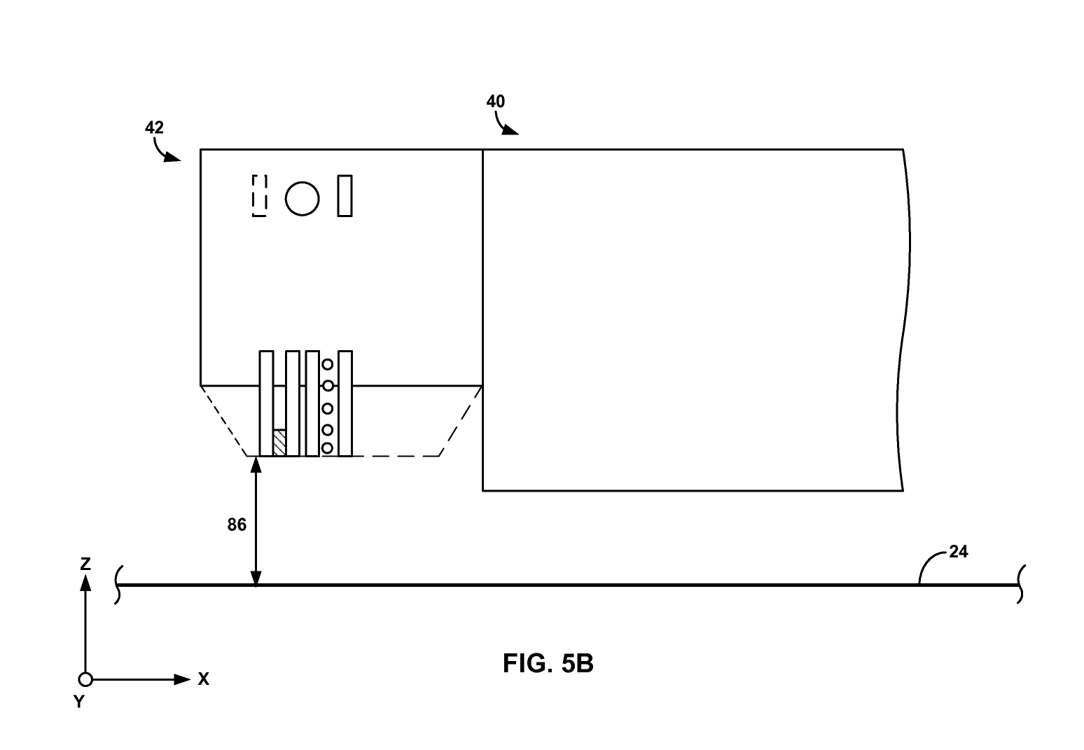

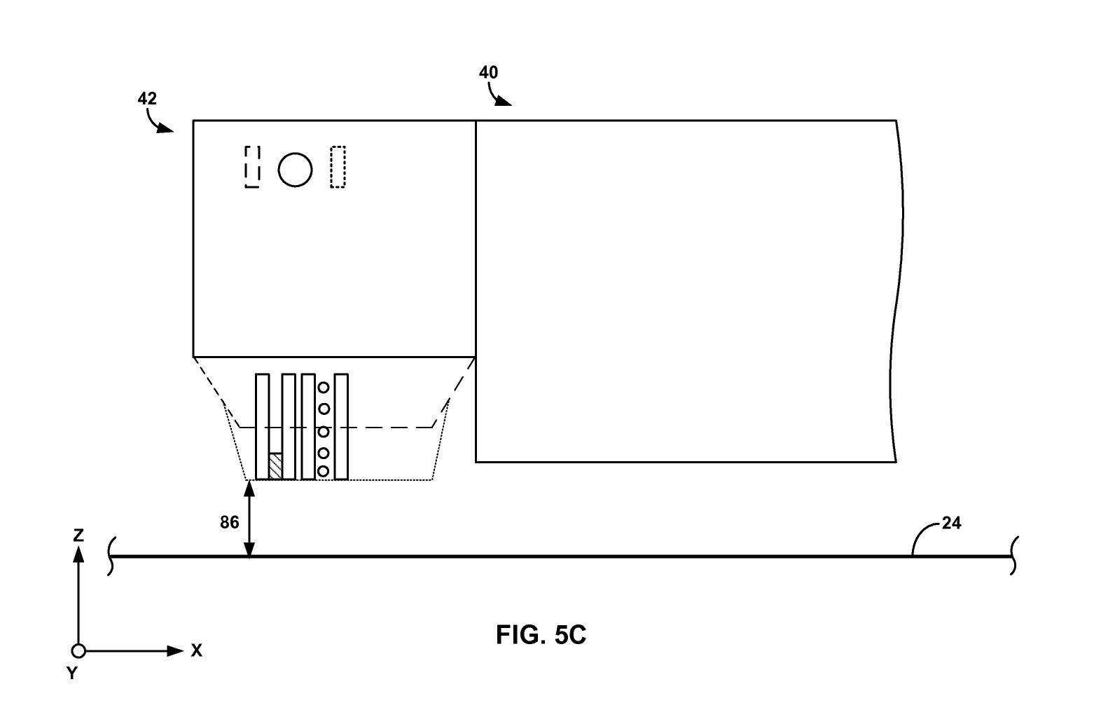

FIGS. 5A-5C are conceptual illustrations of the example transducing device 42 of FIG. 3 showing different example states of deformation. FIG. 5A illustrates transducing device 42 prior to deformation of either permanently deformable material portion 80 or temporarily deformable material portion 82. FIG. 5A further illustrates fly height 86 as the distance separating read element 60 and write element 62 from the top surface of magnetic disc 24 (e.g., in a direction substantially orthogonal to the planar upper surface of the disc). In different examples, fly height 86 may range from approximately 5 nanometers (nm) to approximately 20 nm prior to deformation of permanently deformable material portion 80 and temporarily deformable material portion 82.

FIG. 5B illustrates transducing device 42 after deformation of permanently deformable material portion 80 but prior to deformation of temporarily deformable material portion 82. Deformation of permanently deformable material portion 80 may move read element 60 and/or write element 62 closer to the surface of magnetic disc 24 than before deformation of the material. In some examples, permanently deformable material portion 80 is configured to expand upon the application of heat so that read element 60 and/or write element 62 are moved between approximately 0.25 nanometers (nm) and approximately 15 nm closer to the surface of magnetic disc 24 than before permanently deformable material portion 80 is deformed such as, e.g., between approximately 5 nm and approximately 10 nm closer to the surface of magnetic disc 24. The permanently deformable material portion 80 may remain deformed (e.g., expanded) even after heating element 84 stops delivering heat to the material (e.g., after disc drive 10 is powered off).

FIG. 5C illustrates transducing device 42 after deformation of both permanently deformable material portion 80 and temporarily deformable material portion 82. Deformation of temporarily deformable material portion 82 may move read element 60 and/or write element 62 closer to the surface of magnetic disc 24 than before deformation of the temporarily deformable material portion. Further, depending on the configuration of transducing device 42, deformation of temporarily deformable material portion 82 may position read element 60 and/or write element 62 closer to the surface of magnetic disc 24 than where the read element and/or write element are positioned after deformation of the permanently deformable material portion (e.g., as illustrated in FIG. 5B).

In some examples, temporarily deformable material portion 82 is configured to expand upon the application of heat so that read element 60 and/or write element 62 are moved between approximately 0.25 nanometers (nm) and approximately 15 nm closer to the surface of magnetic disc 24 than before temporarily deformable material portion 82 is deformed such as, e.g., between approximately 5 nm and approximately 10 nm closer to the surface of magnetic disc 24. The expansion of temporarily deformable material portion 82 may be additive to the expansion of permanently deformable material portion 80 such that when both material portions are deformed, read element 60 and/or write element 62 are moved between approximately 0.50 nanometers (nm) and approximately 30 nm closer to the surface of magnetic disc 24 such as, e.g., between approximately 10 nm and approximately 20 nm closer to the surface of magnetic disc 24 than before either material portion is deformed. Temporarily deformable material portion 82 may return to its substantially undeformed size and shape (e.g., as illustrated in FIG. 5B) after heating element 84 stops delivering heat to the material (e.g., after disc drive 10 is powered off).

Different disc drive and transducing device configurations have been described in relation to FIGS. 1-5. FIG. 6 is a flow chart illustrating an example method for operating a transducing device to adjust a fly height of the device. For ease of description, the method of FIG. 6 for operating a transducing device to adjust a fly height of the device is described with respect to disc drive 10 (FIG. 1) and transducing device 42 (FIG. 3). In other examples, however, the method of FIG. 6 may be performed using disc drives or transducing devices having different configurations.

As shown in FIG. 6, transducing device 42 may be positioned over magnetic disc 24 of disc drive 10 while the disc is rotating (200). Rotation of magnetic disc 24 may create air movement that acts on air bearing surface 48 of slider 20, causing the slider to lift and fly above the surface of the magnetic disc. In some examples, positioning transducing device 42 over magnetic disc 24 (200) includes moving actuator arm 14 from a park position in which slider 20 is positioned off to the side of the magnetic disc. In other examples, positioning transducing device 42 over magnetic disc 24 (200) includes sliding slider 20 along magnetic disc 24 until a relative velocity between the slider 20 and magnetic disc 24 is sufficient to produce a lift force adequate to cause slider 20 to fly above the surface of the disc.

The technique of FIG. 6 includes optionally determining a fly height between transducing element 54 and a top surface of magnetic disc 24 (202). In one example, the fly height is determined before permanently deformable material portion 80 is permanently deformed. In another example, the fly height is determined before temporarily deformable material portion 82 is temporarily deformed but after permanently deformable material portion 80 is permanently deformed. In either example, determining a fly height between transducing element 54 and a top surface of magnetic disc 24 (202) may include determining a local fly height between read element 60 and/or write element 62 and the top of magnetic disc 24.

After optionally determining a fly height (202), the technique of FIG. 6 includes deforming permanently deformable material portion 80 (204). Electrical energy may be delivered to heating element 84 which then converts the electrical energy into thermal energy. Permanently deformable material portion 80 may expand in response to the heat generated by heating element 84. In some examples, the fly height between transducing element 54 and a top surface of magnetic disc 24 is continuously measured (202) while permanently deformable material portion is permanently deformed.

In some examples, permanently deformable material portion 80 may be heated until the fly height between read element 60 and/or write element 62 and the top of magnetic disc 24 reaches a predetermined value. The predetermined value may be between approximately 2 nm and approximately 10 nm, although other values are possible. Upon reaching the predetermined value, electrical energy stops being delivered to heating element 84 to stop further expansion of permanently deformable material portion 80. Permanently deformable material portion 80 may maintain its expanded size and/or shape even after the material returns to ambient temperature (e.g., disc drive 10 is powered off).

In addition, the technique of FIG. 6 includes deforming temporarily deformable material portion 82 (206). Electrical energy may be delivered to heating element 84 to produce thermal energy. Temporarily deformable material portion 82 may expand in response to the heat generated by heating element 84. In some examples, temporarily deformable material portion 82 deforms at a lower temperature than permanently deformable material portion 80. In these examples, less energy may be delivered to heating element 84 when deforming temporarily deformable material portion 82 than when deforming permanently deformable material portion 80. Further, when heating temporarily deformable material portion 82 to expand the material portion, any incidental heating of permanently deformable material portion 80 may not further permanently expand the permanently deformable material. Rather, heating element 84 may heat transducing device 42 above a temperature required to temporarily deform temporarily deformable material portion 82 but below permanently deformable material portion 80.

In some examples, temporarily deformable material portion 82 may be heated until the fly height between read element 60 and/or write element 62 and the top of magnetic disc 24 reaches a predetermined value. The predetermined value may be between approximately 0.5 nm and approximately 2.5 nm, although other values are possible. Upon reaching the predetermined value, electrical energy stops being delivered to heating element 84 to stop further expansion of temporarily deformable material portion 80. Temporarily deformable material portion 82 may maintain its expanded size and/or shape until the material begins to cool. Temporarily deformable material portion 82 may return to an undeformed size and/or shape when the material returns to ambient temperature (e.g., disc drive 10 is powered off).

While the example technique of FIG. 6 has been described as being performed while transducing device 42 is positioned over a rotating magnetic disc 24 (200), one or more (e.g., all) of the steps of the technique may be preformed while transducing device 42 is not positioned over a rotating magnetic disc 24. For example, permanently deformable material portion 80 may be permanently deformed (204) and/or temporarily deformable material portion 82 may be temporarily deformed (206) while magnetic disc 24 is not rotating or while transducing device 42 is not positioned above the disc.

Various examples have been described. These and other examples are within the scope of the following claims.

1. A transducing device comprising:
a transducing element positioned within an electrically insulating material portion;
at least one heating element positioned within the electrically insulating material portion and separate from write coils positioned in the electrically insulating material portion;
a permanently deformable material formed within the electrically insulating material portion, the permanently deformable material configured to permanently deform in response to heat from the at least one heating element; and
a temporarily deformable material different than the permanently deformable material and formed within the electrically insulating material portion, the temporarily deformable material configured to temporarily deform in response to heat from the at least one heating element.

2. The transducing device of claim 1, wherein the transducing element comprises a magnetic write element that is configured to generate a magnetic field sufficient to magnetize a discrete domain of a magnetic storage medium, and a magnetic read element that is configured to detect a magnetic field of the discrete domain of the magnetic storage medium.

3. The transducing device of claim 1, wherein the transducing element defines an air bearing surface, the permanently deformable material formed as a layer positioned a first distance from the air bearing surface, and the temporarily deformable material formed as a layer positioned a second distance from the air bearing surface.

4. The transducing device of claim 3, wherein the layer of permanently deformable material is substantially parallel to the air bearing surface, the layer of temporarily deformable material is substantially parallel to the air bearing surface, and wherein the first distance is greater than the second distance.

5. The transducing device of claim 1, wherein the permanently deformable material is configured to retain a deformed shape after removing heat supplied by the at least one heating element, and the temporarily deformable material is configured to return to an undeformed shape after removing heat supplied by the at least one heating element.

6. The transducing device of claim 5, wherein the permanently deformable material exhibits a yield stress of less than 50 megapascals, and the temporarily deformable material portion exhibits a yield stress of greater than 60 megapascals.

7. The transducing device of claim 1, wherein the at least one heating element comprises a first heating element positioned closer to the permanently deformable material than the temporarily deformable material, and a second heating element positioned closer to the temporarily deformable material than the permanently deformable material.

8. The transducing device of claim 1, wherein the transducing element defines an air bearing surface, the permanently deformable material is configured to expand a region of the transducing element from approximately 1 nanometer (nm) to approximately 10 nm away from the air bearing surface, and the temporarily deformable material is configured to further expand the region of the transducing element from approximately 1 nm to approximately 10 nm away from the air bearing surface.

9. A disc drive comprising:
a rotatable magnetic storage disc; and
a slider assembly including a slider body positioned adjacent the rotatable magnetic storage disc and a transducing device, wherein the transducing device includes:
a transducing element positioned within an electrically insulating material portion,
at least one heating element positioned within the electrically insulating material portion and separate from write coils positioned in the electrically insulating material portion,
a permanently deformable material formed within the electrically insulating material portion, the permanently deformable material configured to permanently deform in response to heat from the at least one heating element, and
a temporarily deformable material different than the permanently deformable material and formed within the electrically insulating material portion, the temporarily deformable material configured to temporarily deform in response to heat from the at least one heating element.

10. The disc drive of claim 9, wherein the transducing element defines an air bearing surface, the permanently deformable material formed as a layer positioned a first distance from the air bearing surface, and the temporarily deformable material formed as a layer positioned a second distance from the air bearing surface.

11. The disc drive of claim 10, wherein the layer of permanently deformable material is substantially parallel to the air bearing surface, the layer of temporarily deformable material is substantially parallel to the air bearing surface, and wherein the first distance is greater than the second distance.

12. The disc drive of claim 9, wherein the permanently deformable material is configured to retain a deformed shape after removing heat supplied by the at least one heating element, and the temporarily deformable material is configured to return to an undeformed shape after removing heat supplied by the at least one heating element.

13. The disc drive of claim 9, wherein the permanently deformable material exhibits a yield stress of less than 50 megapascals, and the temporarily deformable material portion exhibits a yield stress of greater than 60 megapascals.

14. The disc drive of claim 9, wherein the permanently deformable material is configured to permanently expand a region of the transducing element so as to reduce a fly height between the transducing element and the rotatable magnetic storage disc from approximately 1 nanometer (nm) to approximately 10 nm, and the temporarily deformable material is configured to further expand the region of the transducing element so as to reduce a fly height between the transducing element and the rotatable magnetic storage disc an additional from approximately 1 nanometer (nm) to approximately 10 nm.

15. A method comprising:
deforming a permanently deformable material formed within an electrically insulating material portion, the permanently deformable material deforming in response to heat from at least one heating element positioned within the electrically insulating material portion; and
deforming a temporarily deformable material different than the permanently deformable material and formed within the electrically insulating material portion, the temporarily deformable material deforming in response to heat from the at least one heating element,
wherein the electrically insulating material portion includes a transducing element and write coils separate from the at least one heating element positioned within the electrically insulating material portion.

16. The method of claim 15, further comprising positioning the transducing element over a rotating magnetic storage disc prior to deforming the permanently deformable material.

17. The method of claim 15, further comprising determining a fly height between the transducing element and a rotatable magnetic storage disc, wherein deforming the permanently deformable material comprises deforming the permanently deformable material until the fly height is less than 10 nanometers.

18. The method of claim 15, wherein deforming the permanently deformable material and deforming the temporarily deformable material each comprise supplying electrical energy to the at least one heating element.

19. The method of claim 15, wherein the permanently deformable material exhibits a yield stress of less than 50 megapascals, and the temporarily deformable material exhibits a yield stress of greater than 60 megapascals.

20. The method of claim 15, wherein deforming the permanently deformable material comprises expanding the permanently deformable material so as to reduce a fly height between the transducing element and a rotatable magnetic storage disc from approximately 1 nanometer (nm) to approximately 10 nm, and deforming the temporarily deformable material comprises expanding the temporarily deformable material so as to reduce the fly height an additional from approximately 1 nanometer (nm) to approximately 10 nm.
